(19) United States
(12) Patent Application Publication
(10) Pub. No.: US 2009/0170992 A1
(43) Pub. Date: Jul. 2, 2009

(54) ETCH RESISTANT POLYMER COMPOSITION

(75) Inventors: Ilya L. Rushkin, Acton, MA (US); Matthew A. Simpson, Sudbury, MA (US); Rojendra Singh, Natick, MA (US)

Correspondence Address: LARSON NEWMAN ABEL & POLANSKY, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 12/344,354

(22) Filed: Dec. 26, 2008

Related U.S. Application Data
(60) Provisional application No. 61/017,398, filed on Dec. 28, 2007.

(51) Int. Cl. C08K 3/22; C08K 3/38; C08K 3/32; B28B 3/00

(52) U.S. Cl. 524/403; 524/430; 524/437; 524/405; 524/406; 524/409; 524/407; 524/408; 524/413; 524/414; 524/431; 524/432; 524/433; 264/642

(57) ABSTRACT

A composite material includes a polymer and a colloidal metal oxide. The composite material has a Plasma Etch Index of 40 relative to a polymer absent the colloidal metal oxide.

### CROSS REFERENCE TO RELATED APPLICATION(S)

The present application is a non-provisional application of U.S. Provisional Patent Application No. 61/017,398, filed Dec. 28, 2007, entitled “ETCH RESISTANT POLYMER COMPOSITION,” naming inventors Ilya L. Rushkin and Matthew A. Simpson, which application is incorporated by reference herein in its entirety.

### FIELD OF THE DISCLOSURE

This disclosure, in general, relates to composite materials and methods for making such composite materials.

### BACKGROUND

In industries such as aerospace, automobile manufacturing, and semiconductor manufacturing, increasingly intricate components and tools are used in high temperature environments. Traditionally, manufacturers have used metal and ceramic materials to form such components and tools based on the tolerance of such materials with high temperatures.

Increasingly, polymeric materials are being used as alternatives to metal and ceramic materials. In general, polymeric materials are less expensive, lighter in weight, and easier to form than metal and ceramic materials. Typically, polymer materials are significantly lighter than metal. In addition, polymers often cost less than 1/10 the cost of ceramic materials, can be molded at lower temperatures than ceramics, and are easier to machine than ceramic materials.

However, unlike metal and ceramic materials, polymeric materials tend to etch rapidly under conditions that lead to plasma. For instance, when exposed to agents such as atomic oxygen or fluorine, polymeric materials tend to lose mass. Such a loss of mass often results in changes in the dimensions of an article formed of such polymeric materials. In addition, such a loss of mass typically results in reduced mechanical strength, such as a decrease in tensile strength and elongation properties.

Such susceptibility to plasma is especially unacceptable in semiconductor manufacturing applications. Often, plasma etching is used in at least one process step for forming semiconductor devices. Traditional polymers, which degrade under such conditions, are unsuitable for use as carriers, trays, clamp rings for wafers, end effectors, dielectrics for electrostatic chucks, seals and other components used in semiconductor processes. In contrast, the use of robust etch-resistant polymers for such applications improves the process for making semiconductors, because of the advantages of polymers explained above.

As such, an improved polymeric material would be desirable.

### SUMMARY

In a particular embodiment, a composite material includes a polymer and a colloidal metal oxide. The composite material exhibits a Plasma Etch Index of 40 relative to the polymer absent the colloidal metal oxide.

In another exemplary embodiment, a method of forming a plasma resistant composite material includes preparing a slurry comprising a thermoplastic polymer, a colloidal metal oxide suspension, and a solvent. The method further includes removing the solvent to form a polymer matrix in which the colloidal metal oxide is dispersed.

In a further exemplary embodiment, a method of forming a composite material includes preparing a mixture comprising a polyamic acid precursor and a colloidal metal oxide suspension. The polyamic acid precursor reacts to form polyamic acid. The method further includes imidizing the polyamic acid to form a polyimide. The polyimide forms a polymer matrix in which the colloidal metal oxide is dispersed.

### DETAILED DESCRIPTION

In a particular embodiment, a composite material includes a polymer and a colloidal metal oxide. The polymer forms a matrix in which the colloidal metal oxide is dispersed. In an exemplary embodiment, the composite material exhibits an improved Plasma Etch Index. The Plasma Etch Index is the percent (%) increase in plasma etch resistance of the composite material containing the colloidal metal oxide compared to the polymer absent the colloidal metal oxide. In an embodiment, the Plasma Etch Index is at least about 40.

In an embodiment, the composite material includes the colloidal metal oxide dispersed in a polymer matrix. In an exemplary embodiment, the polymer includes a thermoplastic material. The thermoplastic material forms a matrix in which the colloidal metal oxide is dispersed. In an embodiment, polymer precursors, monomers, polymers, and resins may be used to form the thermoplastic material in which the colloidal metal oxide is dispersed. The polymer precursors, monomers, polymers, and resins are dependent on the thermoplastic material desired. Exemplary thermoplastic materials include polyvinyl alcohol, fluoropolymers, polycarbonates, polyorganosiloxanes, and polyesters. In another embodiment, the thermoplastic material is polyvinyl alcohol.

In a further embodiment, the polymer is a thermoset polymer. In a particular embodiment, the thermoset polymer is a moldable powder. Alternatively, the polymer may be formable through hot processing, such as hot compression molding or direct forming. Compression moldable powders are powders that may be formed into articles through compression and sintering, the sintering being either concurrent with compression or following compression. Direct formable powders are compression moldable powders that may be compressed into a green article and subsequently sintered.

In a particular embodiment, the polymer is a polyimide. Particular varieties of polyimide may act as thermoplastic or thermoset materials. In particular, the polyimide material may be in the form of a hot compression moldable powder, such as a direct formable powder.

The composite material includes a colloidal metal oxide dispersed in the polymer matrix. In general, the colloidal metal oxide is derived from a colloidal suspension. In an example, the colloidal metal oxide particles have an average particle size not greater than about 100.0 microns, such as not greater than about 45.0 microns, or not greater than about 5.0 microns. For example, the colloidal metal oxide particles may have an average particle size not greater than about 150.0 nanometers (nm), such as not greater than about 100.0 nm, such as not greater than about 50.0 nm, or not greater than about 20.0 nm. Further, the average particle size may be at least about 1.0 nm, such as at least about 5.0 nm. In an embodiment, the colloidal metal oxide particles have an average particle size of about 5.0 nm to about 20.0 nm.

The colloidal metal oxide may include an oxide of a metal or a semi-metal selected from groups 1 through 16 of the periodic table. In particular, the colloidal metal oxide may be an oxide of a metal or a semi-metal selected from groups 1 through 13, group 14 at or below period 3, group 15 at or below period 3, or group 16 at or below period 5. For example, the colloidal metal oxide may include an oxide of a metal or semi-metal selected from the group consisting of aluminum, antimony, barium, bismuth, boron, calcium, cerium, chromium, cobalt, copper, gallium, hafnium, iron, magnesium, manganese, molybdenum, nickel, niobium, phosphorous, silicon, tantalum, tellurium, tin, titanium, tungsten, vanadium, yttrium, zirconium, zinc, and the rare earths. In a particular embodiment, the colloidal metal oxide may include a metal oxide of aluminum, antimony, boron, calcium, gallium, hafnium, manganese, molybdenum, phosphorous, tantalum, tellurium, tin, tungsten, yttrium, zinc or a mixture thereof. In a particular example, the colloidal metal oxide includes an oxide of silicon. In another embodiment, the colloidal metal oxide includes an oxide of cerium. In a further embodiment, the colloidal metal oxide includes an oxide of yttrium. In an example, the colloidal metal oxide is substantially free of chelated metal oxides. “Substantially free” as used herein refers to a composite that contains no greater than about 5.0%, such as less than about 1.0%, such as less than about 0.5%, or even less than about 0.1% chelated metal oxide, based on the total weight of the composite, wherein the chelated metal oxide does not impact the physical properties of the composite.

In an embodiment, the colloidal metal oxide is derived from a suspension of metal oxides of particular dimension. For instance, the colloidal metal oxide includes colloidal dispersions or suspension of the metal oxide particles in a liquid medium. Any appropriate liquid medium for suspending colloidal metal oxide is envisioned. The liquid medium may be chosen depending on the colloidal metal oxide. In an embodiment, the liquid medium is an organic medium, such as an organic medium compatible with the polymer or an organic medium at least partially miscible with solvents used in conjunction with the polymer. In an exemplary embodiment, the organic medium is propylene glycol methyl ether acetate. In another exemplary embodiment, the liquid medium is an aqueous medium.

In particular, the colloidal metal oxide is formed in solution and maintained in solution until processing with the polymer or polymer precursors. The colloidal metal oxide may be formed in an aqueous medium or in an organic medium. Any appropriate method for suspending the colloidal metal oxide in a liquid medium is envisioned. The liquid medium may subsequently be replaced by a liquid medium compatible with the polymer process.

In an exemplary embodiment, the composite material includes about 0.1 wt % to about 50.0 wt % colloidal metal oxide, based on the total weight of the composite material. For example, the composite material may include about 0.1 wt % to about 20.0 wt % of the colloidal metal oxide, such as about 0.1 wt % to about 10.0 wt % of the colloidal metal oxide, or about 0.1 wt % to about 5.0 wt % of the colloidal metal oxide. In a particular example, the composite material may include less than about 5.0 wt %, such as about 0.1 wt % to about 2.5 wt % of the colloidal metal oxide, such as about 0.5 wt % to about 2.5 wt % of the colloidal metal oxide, or about 0.5 wt % to about 1.5 wt % of the colloidal metal oxide.

In another exemplary embodiment, the composite material may include large amounts of a filler in addition to the colloidal metal oxide, such as a non-carbonaceous filler. In particular, the composite material may include at least about 55 wt % of a non-carbonaceous filler. Alternatively, the composite material may be free of non-carbonaceous filler other than the colloidal metal oxide. Further, the composite material may include a coupling agent, a wetting agent, or a surfactant. In a particular embodiment, the composite material is free of coupling agents, wetting agents, and surfactants.

In addition, the composite material may include additives, such as carbonaceous materials. Carbonaceous materials are those materials, excluding polymers, that are formed predominantly of carbon (or organic materials processed to form predominantly carbon), such as graphite, amorphous carbon, diamond, carbon fibers, and fullerenes. In particular, the composite material may include graphite or amorphous carbon. In an exemplary embodiment, the composite material includes a carbonaceous additive in an amount of about 0.0 wt % to about 45.0 wt %, such as about 10.0 wt % to about 40.0 wt % or about 15.0 wt % to about 25.0 wt %. Alternatively, particular embodiments are free of carbonaceous materials.

In an exemplary method, the composite material may be formed by preparing a mixture including preparing a slurry that includes a polymeric material, a solvent, and a colloidal metal oxide suspension. The colloidal metal oxide suspension may include metal oxide particulate that is milled prior to preparing the mixture. A solvent may be selected whose functional groups do not react with the polymer or its precursors to any appreciable extent. The solvent may also be blend of solvents. The method further includes removing the solvent to form a polymer matrix in which the colloidal metal oxide is dispersed.

Depending on the polymer formation process, the colloidal metal oxide may be added prior to polymerization, during polymerization, after polymerization, or a combination thereof. For solution-formed polymers, polymeric reactants and the colloidal metal oxide may be provided in solvent mixtures or added to solvent mixtures.

The solvent may be a polar solvent, a non-polar solvent or a mixture thereof. In an embodiment, the solvent may be a polar protic solvent. An exemplary polar protic solvent includes water, methanol, acetic acid, or a mixture thereof. In an exemplary embodiment, the solvent is an aprotic dipolar organic solvent. An exemplary aprotic dipolar solvent includes N,N-dialkylcarboxylamide, N,N-dimethylformamide, N,N-dimethylacetamide, N,N-diethylformamide, N,N-diethylacetamide, N,N-dimethylmethoxyacetamide, N-methyl caprolactam, dimethylsulfoxide, N-methyl-2-pyrrolidone, tetramethyl urea, pyridine, dimethylsulfone, hexamethylphosphoramide, tetramethylene sulfone, formamide, N-methylformamide, butylrolactone, or a mixture thereof. An exemplary non-polar solvent includes benzene, benzonitrile, dioxane, xylene, toluene, cyclohexane or a mixture thereof. Other exemplary solvents are of the halohydrocarbon class and include, for example, chlorobenzene.

In an exemplary embodiment, the solvent mixture includes a mixture of at least two solvents. The solvent mixture may result from mixing prior to adding reactant, may result from combining two reactant mixtures, or may result from addition of solvents or water entraining components during various parts of the process.

In a further exemplary method for forming the composite material, the polymer matrix may be a polyimide matrix. Further, the polyimide may be the imidized product of polyamic precursors. In particular, one of two methods to form the polyimide matrix may be employed. The first method involves reaction of dianhydrides with diamines in the presence of a mixture of solvents to form a high molecular weight polyamic acid, followed by imidization at elevated temperatures. In a second method, polyimide powder is prepared from a concentrated solution of dianhydride diesters with diamine components in a suitable solvent. The concentrated solution is heated to effect polycondensation and imidization reactions.

For example, the first method to form the composite material includes preparing a mixture including a polyamic acid precursor and a colloidal metal oxide suspension. In an embodiment, the polyamic acid precursor may be an unreacted polyamic acid precursor. Further, the colloidal metal oxide suspension may include metal oxide particulate that is milled prior to preparing the mixture. The polyamic acid precursor may react, such as with a second polyamic acid precursor, to form polyamic acid. The method further includes imidizing or dehydrating the polyamic acid to form a polyimide matrix including the colloidal metal oxide.

An exemplary polyamic acid precursor includes a chemical species that may react with itself or another species to form polyamic acid, which may be dehydrated to form polyimide. In particular, the polyamic acid precursor may be one of a dianhydride or a diamine. Dianhydride and diamine may react to form polyamic acid, which may be imidized to form polyimide.

In an exemplary embodiment, the polyamic acid precursor includes dianhydride, and, in particular, aromatic dianhydride. An exemplary dianhydride includes pyromellitic dianhydride, 2,3,6,7-naphthalenetetracarboxylic acid dianhydride, 3,3′,4,4′-diphenyltetracarboxylic acid dianhydride, 1,2,5,6-naphthalenetetracarboxylic acid dianhydride, 2,2′,3,3′-diphenyltetracarboxylic acid dianhydride, 2,2-bis-(3,4-dicarboxyphenyl)-propane dianhydride, bis-(3,4-dicarboxyphenyl)-sulfone dianhydride, bis-(3,4-dicarboxyphenyl)-ether dianhydride, 2,2-bis-(2,3-dicarboxyphenyl)-propane dianhydride, 1,1-bis-(2,3-dicarboxyphenyl)-ethane dianhydride, 1,1-bis-(3,4-dicarboxyphenyl)-ethane dianhydride, bis-(2,3-dicarboxyphenyl)-methane dianhydride, bis-(3,4-dicarboxyphenyl)-methane dianhydride, 3,4,3′,4′-benzophenonetetracarboxylic acid dianhydride or a mixture thereof. In a particular example, the dianhydride is pyromellitic dianhydride (PMDA). In another example, the dianhydride is benzophenonetetracarboxylic acid dianhydride (BTDA), or diphenyltetracarboxylic acid dianhydride (BPDA).

In another exemplary embodiment, the polyamic acid precursor includes diamine. An exemplary diamine includes oxydianiline (ODA), 4,4′-diaminodiphenylpropane, 4,4′-diaminodiphenylmethane, 4,4′-diaminodiphenylamine, benzidine, 4,4′-diaminodiphenyl sulfide, 4,4′-diaminodiphenyl sulfone, 3,3′-diaminodiphenyl sulfone, 4,4′-diaminodiphenyl ether, bis-(4-aminophenyl)diethylsilane, bis-(4-aminophenyl)-phenylphosphine oxide, bis-(4-aminophenyl)-N-methylamine, 1,5-diaminonaphthalene, 3,3′-dimethyl-4,4′-diaminobiphenyl, 3,3′-dimethoxybenzidine, 1,4-bis-(p-aminophenoxy)-benzene, 1,3-bis-(p-aminophenoxy)-benzene, m-phenylenediamine (MPD) or p-phenylenediamine (PPD), or a mixture thereof. In a particular example, the diamine is oxydianiline (ODA). In another example, the diamine is m-phenylenediamine (MPD) or p-Phenylenediamine (PPD).

The polyamic acid precursors, and, in particular, dianhydride and diamine, may react to form polyamic acid, which is imidized to form polyimide. In a particular embodiment, the polyimide includes polyetherimide, such as the imidized product of PMDA and ODA. The polyimide forms the polymer matrix of a composite material in which a colloidal metal oxide may be dispersed.

In an embodiment, a solvent is used for the imidization product of the polyamic acid precursors to produce the composite material with a polyimide matrix and the colloidal metal oxide dispersed therein. In addition to being a solvent for the polyamic acid, the solvent is typically a solvent for at least one of the reactants (e.g., the diamine or the dianhydride). In a particular embodiment, the solvent is a solvent for both of the diamine and the dianhydride. In one exemplary embodiment, the solvent is a mixture of solvents. For instance, the resulting solvent mixture, such as the solvent mixture during polyamic acid imidization, includes an aprotic dipolar solvent and a non-polar solvent. The aprotic dipolar solvent and non-polar solvent may form a mixture having a ratio of 1:9 to 9:1 aprotic dipolar solvent to non-polar solvent, such as 1:3 to 6:1. For example, the ratio may be 1:1 to 6:1, such as 3.5:1 to 4:1 aprotic dipolar solvent to non-polar solvent.

According to an embodiment, the colloidal metal oxide suspension may be added along with at least one polyamic acid precursor prior to polymerization of the polyamic acid precursors. For example, the addition may be performed with a polyamic acid precursor in a solvent. In an example, the addition may be performed under high shear conditions. In a particular embodiment, the colloidal metal oxide particulate in the suspension may be milled, such as through ball milling.

In general, the polyamic acid reaction is exothermic. As such, the mixture may be cooled to control the reaction. In a particular embodiment, the temperature of the mixture may be maintained or controlled at about −10° C. to about 100° C., such as about 25° C. to about 70° C.

Once formed, the polyamic acid may be dehydrated or imidized to form polyimide. The polyimide may be formed in mixture from the polyamic acid mixture. For example, a Lewis base, such as a tertiary amine, may be added to the polyamic acid mixture and the polyamic acid mixture heated to form a polyimide mixture. Portions of the solvent may act to form azeotropes with water formed as a byproduct of the imidization. In an exemplary embodiment, the water byproduct may be removed by azeotropic distillation.

In another exemplary embodiment, the polyimide may be precipitated from the polyamic acid mixture, for example, through addition of a dehydrating agent. An exemplary dehydrating agent includes a fatty acid anhydride formed from acetic acid, propionic acid, butyric acid, or valeric acid, aromatic anhydride formed from benzoic acid or napthoic acid, anhydride of carbonic acid or formic acid, aliphatic ketene, or any mixture thereof.

In general, the polymer product forms solids that are typically filtered, washed, and dried. For example, polyimide precipitate may be filtered and washed in a mixture including methanol, such as a mixture of methanol and water. The washed polymer may be dried at a temperature between about 150° C. and about 300° C. for a period between 5 and 30 hours and, in general, at or below atmospheric pressure, such as partial vacuum (500-700 torr) or full vacuum (50-100 torr). As a result, a composite material is formed including a polymer matrix having colloidal metal oxide dispersed therein. The colloidal metal oxide is generally evenly dispersed.

In a second method, a polyimide powder is prepared from a concentrated solution of dianhydride diester and diamine components in a suitable solvent. For example, a dianhydride diester solution may be formed by reacting a dianhydride with an alcohol. In particular, dianhydride diesters may be derived from the above-identified dianhydrides in the presence of an alcohol, such as methanol, ethanol, propanol, or any combination thereof. To form a concentrated solution, a diamine component may be added to the dianhydride diester solution. For example, the diamine component may be selected from the group of diamine components identified above.

The concentrated solution may be heated to a temperature in a range of about 120° C. to about 350° C. to affect polycondensation and imidization reactions. In an example, the concentrated solution is heated under vacuum. In another exemplary embodiment, the concentrated solution may be heated in an inert atmosphere, such as a non-reactive gas including a noble gas, nitrogen, or any combination thereof. In an embodiment, the colloidal metal oxide suspension may be added to the solution at any stage prior to imidization. The resulting polyimide powder having colloidal metal oxide dispersed therein may be milled to obtain a desired particle size. In an example, a polyimide powder having colloidal metal oxide dispersed therein formed through such a method may be shaped using a method such as hot compressing molding.

To form an article, the composite material may be hot pressed or press sintered. In another example, the composite material may be pressed and subsequently sintered to form the component. For example, the polymer, such as the polyimide, may be compression molded using high pressure sintering at temperatures of about 250° C. to about 450° C., such as about 350° C. and pressures at least about 351 kg/cm² (5 ksi), such as about 351 kg/cm² (5 ksi) to about 1406 kg/cm² (20 ksi) or, in other embodiments, as high as about 6250 kg/cm² (88.87 ksi). In an embodiment, the polymer may be directly formable. Direct forming includes compressing the polymeric powder at a pressure greater than 4 ksi, such as 5.5 ksi, to form a green component and subsequently sintering the green component at a temperature of at least about 350° C. For example, to prepare a tensile bar for testing, a tensile bar is compressed at 55,000 psi and sintered at a temperature of about 413° C. for about 4 hours.

In an exemplary embodiment, the composite material exhibits improved plasma etch resistance. For instance, the Plasma Etch Rate is not greater than about 10.0 weight %, such as not greater than about 5.0 weight %, or even not greater than about 3.5 weight %, based on a weight change after 180 minutes of plasma etching. The Plasma Etch Rate is the weight loss after 180 minutes measured using ASTM D-638 tensile bars in a March plasma etcher at a power of 400 W, a pressure of 250 mTorr to 350 mTorr, using oxygen gas plasma.

In an embodiment, the composite material exhibits a desirable Plasma Etch Index is at least about 40, such as at least about 50, such as at least about 60, or even at least about 75. The Plasma Etch Index is the percent difference between the Plasma Etch Rate of the composite relative to the Plasma Etch Rate of the polymer absent the colloidal metal oxide.

In another embodiment, the composite material has a Plasma Recession Rate of not greater than about 10.0 nm/s, such as not greater than about 7.5 nm/s, such as not greater than about 5.0 nm/s, or even not greater than about 4.5 nm/s. The Plasma Recession Rate is the rate of recession measured using ASTM D-638 tensile bars in a March plasma etcher at a power of 400 W, a pressure of 330 mTorr, using an oxygen/carbon tetrafluoride gas plasma mixture.

The composite material may also exhibit improved mechanical properties. For example, the composite material may exhibit improved tensile strength and elongation properties relative to the base polyimide used to form the composite material. For a particular polyimide, such as the imidized product of PMDA and ODA, the tensile strength of the composite material may be at least about 68.9 MPa (10000 psi), such as at least about 72.3 MPa (10500 psi), or at least about 82.0 MPa (11000 psi). The tensile strength and elongation are measured using standard techniques, such as ASTM D6456 using specimens conforming to D1708 and E8.

In addition, the composite material may exhibit an elongation-at-break of at least about 2.5%, such as at least about 5.0% or at least about 10.0%.

### Example 1

A polymer composite is prepared by mixing equal parts of a 5% solution of Elvanol® 51-03 polyvinyl alcohol (PVA) from E.I. DuPont de Nemours & Co. of Wilmington, Del. and a 12 weight % aqueous slurry of cerium oxide nanoparticles of median article size less than about 100 nanometers procured from Saint-Gobain Co. in Worcester, Mass.

The slurry is dried as dense films on alumina substrates and etched in a March PM-600 reactor at 330 mTorr and 400 W using equal volumes of O₂ and CF₄ for a total time of 100 seconds. Recession rate for the plasma etch can be seen in Table 1.

TABLE 1

Recession rate (nm/s)

| | |
|---|---|
| PVA only | 20.0 |
| PVA + colloidal CeO₂ | 4.5 |

As illustrated in Table 1, samples including colloidal cerium oxide exhibit an improved plasma etch rate. For instance, the plasma etch resistance of the composite is improved by about 78% relative to the base polymer.

### Example 2

Samples of a composite material including polyimide and including a colloidal metal oxide suspension are prepared and tested to determine mechanical properties, thermal stability, and plasma etch rate. A mixture of oxydianiline (ODA), N-methylpyrrolidone (NMP), and xylene is prepared. The solution is heated to 155° C. and the residual water is removed as xylene azeotrope. The mixture is cooled to 61° C. and pyromellitic dianhydride (PMDA) is added to the mixture under reaction conditions. The reaction mixtures is heated to 90° C. at which point 123 grams of Organosol® (30% weight solution of 10-15 nm colloidal silica particles in propylene glycol methyl ether acetate) is added. Reaction conditions are adjusted to affect imidization. The resulting mixture is azeotropically distilled and the thus formed polyimide is filtered, washed, and dried.

Another material was prepared as described above, but instead of colloidal silica solution, a fumed silica (15 g) with primary particle size of 10 nm and agglomerate particle size of 30-60 microns was used

The resulting polyimide materials are pressed and sintered into sheets and cut into standard shapes for testing. Table 1 illustrates the influence of the colloidal metal oxide on mechanical properties, such as tensile strength and elongation, and plasma etch rate. Tensile strength and elongation are determined in accordance with ASTM D638. Plasma etch test is determined on tensile bars in a March PM-600 reactor at 250-350 mTorr and 400 W using O₂. Coupon weights are measured at the beginning and end of four 90 minute test exposures after an initial 20 minute burn-in of the samples. After each 90 minute etch cycle, the samples are rotated 90 degrees to reduce inhomogeneity in the etching process. The results of the plasma etch rate (as determined by weight change after 180 minutes of plasma etch) can be seen in Table 2.

TABLE 2

| | Tensile | | |
|---|---|---|---|
| | strength | Elongation to break | Relative Plasma |
| Material | (psi) | (%) | etch rate |
| Polyimide only | 11,620 | 11 | 1 |
| Polyimide + | 10,500 | 5 | 0.3 |
| colloidal SiO₂ | | | |
| Polyimide + fumed | 10,500 | 5 | 1 |
| silica | | | |

As illustrated in Table 2, samples including colloidal metal oxide exhibit an improved plasma etch rate. The use of colloidal silica with a polyimide unexpectedly increases the plasma etch resistance compared to a polyimide with fumed silica having particles of similar size as the colloidal silica particles. For instance, the plasma etch resistance of the composite is improved by about 70%, relative the polymer absent the colloidal metal oxide. Hence, the Plasma Etch Index is about 70. Comparatively, the sample containing the fumed silica has no improvement on its plasma etch resistance.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A composite material comprising a polymer and a colloidal metal oxide, the composite material exhibiting a Plasma Etch Index of 40 relative to the polymer absent the colloidal metal oxide.

2. The composite material of claim 1, wherein the polymer is a thermoplastic or a thermoset.

3. The composite material of claim 1, wherein the polymer is polyimide.

4. The composite material of claim 1, wherein the polymer is polyvinyl alcohol.

5. (canceled)

6. (canceled)

7. (canceled)

8. The composite material of claim 1, wherein the colloidal metal oxide is derived from a colloidal suspension including a metal oxide and a liquid medium.

9. The composite material of claim 8, wherein the metal oxide colloidal suspension is substantially free of chelated metal oxide.

10. (canceled)

11. (canceled)

12. (canceled)

13. The composite material of claim 1, wherein the colloidal metal oxide includes an oxide of a metal or a semi-metal selected from the group consisting of aluminum, antimony, barium, bismuth, boron, calcium, chromium, cobalt, copper, gallium, hafnium, iron, magnesium, manganese, molybdenum, nickel, niobium, phosphorous, silicon, tantalum, tellurium, tin, titanium, tungsten, vanadium, yttrium, zirconium, and zinc, and the rare earths.

14. The composite material of claim 13, wherein the colloidal metal oxide includes an oxide of silicon.

15. The composite material of claim 13, wherein the colloidal metal oxide includes an oxide of yttrium.

16. The composite material of claim 13, wherein the colloidal metal oxide includes an oxide of cerium.

17. The composite material of claim 1, wherein the composite material includes about 0.1 wt % to about 20.0 wt % of the colloidal metal oxide.

18. The composite material of claim 1, wherein the colloidal metal oxide includes metal oxide particles having an average particle size not greater than about 100.0 nanometers.

19. (canceled)

20. (canceled)

21. (canceled)

22. The composite material of claim 1, having a tensile strength of greater than about 10,000 psi.

23. The composite material of claim 1, having an elongation at break of at least about 2.5%

24. (canceled)

25. A method of forming a plasma resistant composite material, the method comprising:
preparing a slurry comprising a thermoplastic polymer, a colloidal metal oxide suspension, and a solvent; and
removing the solvent to form a polymer matrix in which the colloidal metal oxide is dispersed.

26. The method of claim 25, wherein the thermoplastic polymer is polyvinyl alcohol.

27. The method of claim 25, wherein the colloidal metal oxide suspension includes a metal oxide and a liquid medium.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A method of forming a composite material, the method comprising:
preparing a mixture comprising a polyamic acid precursor and a colloidal metal oxide suspension, the polyamic acid precursors reacting to form polyamic acid; and
imidizing the polyamic acid to form a polyimide, the polyimide forming a polymer matrix in which the colloidal metal oxide is dispersed.

41. The method of claim 40, wherein the colloidal metal oxide suspension includes a metal oxide and a liquid medium.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. The method of claim 40, further comprising adding a second polyamic acid precursor to the mixture, resulting in the polyamic acid precursor and the second polyamic acid precursor reacting to form polyamic acid.

56. The method of claim 40, further comprising cooling the mixture.

57. The method of claim 40, wherein imidizing the polyamic acid includes azeotropically distilling the mixture.

58. The method of claim 40, wherein imidizing the polyamic acid includes adding a dehydrating agent to the mixture.

59. The method of claim 40, further comprising press sintering the polymer matrix.

60. The method of claim 40, further comprising pressing the polymer matrix at room temperature to form a composite component; and sintering the composite component after pressing.

61. The method of claim 40, wherein the polyamic acid precursor includes a diamine.

62. The method of claim 40, wherein the polyamic acid precursor includes a dianhydride.
